(19) United States
(12) Patent Application Publication
(10) Pub. No.: US 2007/0002449 A1
(43) Pub. Date: Jan. 4, 2007

(54) Prism sheet and prism sheet module

(75) Inventors: Hsin-Ming Chen, Miao-Li (TW); Yu-Ju Hsu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/455,571

(22) Filed: Jun. 19, 2006

(30) Foreign Application Priority Data
Jun. 17, 2005 (TW) 94210200

(51) Int. Cl. G02B 5/02; G02B 13/20

(52) U.S. Cl. 359/599

(57) ABSTRACT

An exemplary prism sheet (300) includes a substrate (301) having an incident surface (302) and an emitting surface (303) opposite to each other and a plurality of parallel V-shaped grooves (304) provided at the emitting surface, each of the V-shaped grooves maintains an angle relative to a main side of the substrate, and the angle is in the range from 5° to 44.9°. An exemplary prism sheet module (500) includes a first prism sheet (510) above a second prism sheet (520), and at least one of the first and second prism sheets includes a substrate, the substrate includes an incident surface and an emitting surface opposite to each other, and a plurality of parallel V-shaped grooves provided at the emitting surface. Each of V-shaped grooves maintains an angle relative to a main side of the substrate, and the angle is in the range from 5° to 44.9°.

### FIELD OF THE INVENTION

The present invention relates to a prism sheet typically used in an optical system such as that of a liquid crystal display module, and more particularly to a prism sheet and a prism sheet module having V-shaped grooves.

### GENERAL BACKGROUND

With the widespread use of liquid crystal display devices, such as in high-end portable electronic devices, mobile phones, and PDAs (Personal Digital Assistants), the demand for greater picture quality is ever present. In many liquid crystal display devices, a backlight module is needed for supplying light beams to support the display of images.

As shown in FIG. 5, a typical backlight module 100 includes a prism sheet 104, a light guide plate 103, and a reflector 102 arranged in that order from top to bottom. A light source 101 is disposed adjacent to a side surface of the light guide plate 103.

Light beams emitted from the light source 101 are transmitted to and through the light guide plate 103. To prevent loss of light beams leaking out from a bottom of the light guide plate 103, the reflector 102 reflects such light beams back into the light guide plate 103. Overall, the light beams from the light source 101 are converted by the light guide plate 103 to a surface light source at a top of the light guide plate 103. The prism sheet 104 enhances the light beams such that they radiate up within a desired range of viewing angles.

Instead of a single prism sheet, a combination of prism sheets can also be employed. As shown in FIG. 6, a conventional prism sheet module 200 used for a backlight module includes a first prism sheet 210 and a second prism sheet 220. Each of the first and second prism sheets 210, 220 includes parallel V-shaped grooves arranged at an emitting surface thereof. The V-shaped grooves of the first prism sheet 210 are transversely oriented with respect to a main body of the first prism sheet 210, and the V-shaped grooves of the second prism sheet 220 are longways oriented with respect to a main body of the second prism sheet 220. That is, the V-shaped grooves of the first prism sheet 210 are oriented perpendicular to the V-shaped grooves of the second prism sheet 220. This cooperative configuration of the pair of prism sheets 210, 220 can improve the above-described enhancement effect of light beams.

On the other hand, because the V-shaped grooves of the first prism sheet 210 and those of the second prism sheet 220 are perpendicular to each other, any enhancement effect achieved is limited.

What is needed, therefore, is a prism sheet and a prism sheet module that can overcome the above-described deficiencies.

### SUMMARY

In a preferred embodiment, a prism sheet includes a substrate having an incident surface and an emitting surface opposite to each other and a plurality of parallel V-shaped grooves provided at the emitting surface, each of the V-shaped grooves maintains an angle relative to a main side of the substrate, and the angle is in the range from 5° to 44.9°.

In another preferred embodiment, a prism sheet module includes a first prism sheet and a second prism sheet opposite to each other, at least one of the first and second prism sheets includes a substrate which has an incident surface and an emitting surface opposite to each other, and a plurality of parallel V-shaped grooves provided at the emitting surface, each of the V-shaped grooves maintains an angle relative to a main side of the substrate, and the angle is in the range from 5° to 44.9°.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an isometric view of a prism sheet according to a first embodiment of the present invention.

FIG. 2 is an isometric view of a prism sheet according to a second embodiment of the present invention.

FIG. 3 is an exploded, isometric view of a prism sheet module according to a third embodiment of the present invention.

FIG. 4 is an exploded, isometric view of a prism sheet module according to a fourth embodiment of the present invention.

FIG. 5 is an exploded, side view of a conventional backlight module including a single prism sheet.

FIG. 6 is an exploded, isometric view of a conventional prism sheet module.

### DETAILED DESCRIPTION OF PREFERRED EMBODIMENTS

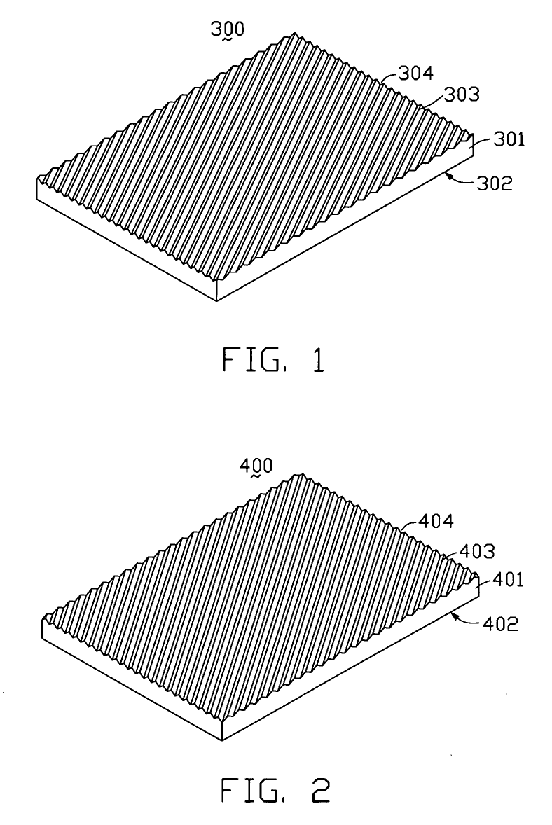

FIG. 1 is a schematic, isometric view of a prism sheet 300 according to a first embodiment of the present invention. The prism sheet 300 includes a substrate 301. The substrate 301 is generally rectangular, and includes an incident surface 302 and an emitting surface 303 opposite to each other. A plurality of V-shaped grooves 304 are defined at the emitting surface 303. The V-shaped grooves 304 are parallel to each other. Each of the V-shaped grooves 304 maintains an angle relative to a long side of the substrate 301, which angle is in the range from 5° to 44.9°. With this angular range, a brightness of a backlight module using the prism sheet 300 can be increased. In a preferred embodiment, the angle is 30°. With this configuration, optical interference fringes can be avoided.

For any particular application using the prism sheet 300, the angle within the range from 5° to 44.9° can configured accordingly to improve and optimize the characteristics of brightness and view angle. Thus for example, a backlight module employing the prism sheet 300 can provide good viewing performance.

FIG. 2 is a schematic, isometric view of a prism sheet 400 according to a second embodiment of the present invention. The prism sheet 400 is similar to the prism sheet 300 of the first embodiment. However, the prism sheet 400 includes a substrate 401, an incident surface 402, an emitting surface 303, and a plurality of V-shaped grooves 404. A longest one of the V-shaped grooves 404 spans from one corner of the substrate 401 to a diagonally opposite corner of the substrate 401. Thus all the other V-shaped grooves 404 are arranged at either side of the longest V-shaped groove 404.

FIG. 3 is a schematic, isometric view of a prism sheet module according to a third embodiment of the present invention. The prism sheet module 500 includes a first prism sheet 510 stacked on a second prism sheet 520. The first prism sheet 510 includes a substrate 511. The substrate 511 is generally rectangular, and includes an incident surface 512 and an emitting surface 513 opposite to each other. A plurality of V-shaped grooves 514 are defined at the emitting surface 513. The V-shaped grooves 514 are parallel to each other. Each of the V-shaped grooves 514 maintains an angle relative to a long side of the substrate 511, which angle is in the range from 5° to 44.9°. In a preferred embodiment, the angle is 30°. The structure of the second prism sheet 520 is similar to that of the first prism sheet 510. The second prism sheet 520 includes a substrate 521, an incident surface 522, an emitting surface 523, and a plurality of V-shaped grooves 514. Each of the V-shaped grooves 524 maintains an angle relative to a long side of the substrate 521, which angle is in the range from 5° to 44.9°. Further, the V-shaped grooves 514 of the first prism sheet 510 are oriented transversely relative to the V-shaped grooves 524 of the second prism sheet 520.

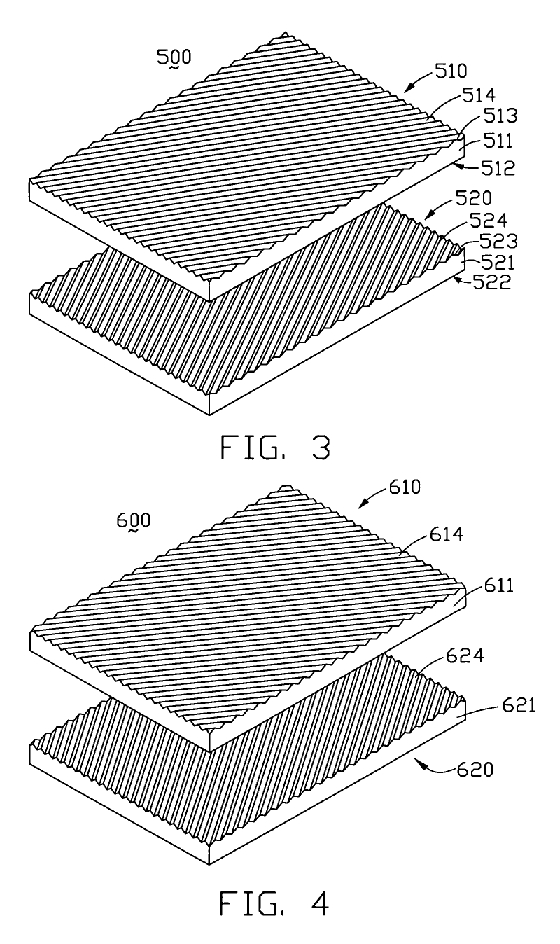

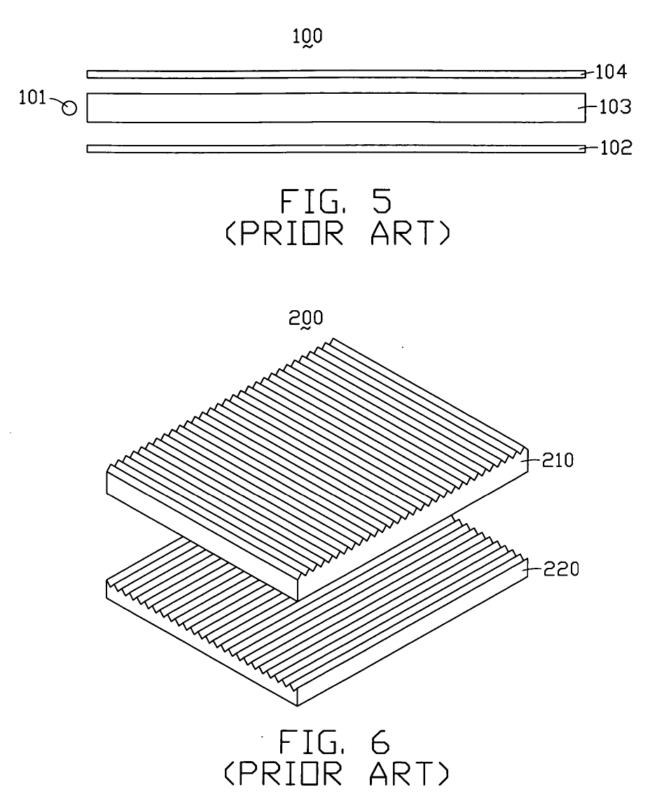

FIG. 4 is a schematic, isometric view of a prism sheet module 600 according to a fourth embodiment of the present invention. The prism sheet module 600 is similar to the prism sheet module 500 of the third embodiment. However, the prism sheet module 600 includes a first prism sheet 610 stacked on a second prism sheet 620. The first prism sheet 610 includes a substrate 611 having a plurality of V-shaped grooves 614. The second prism sheet 610 includes a substrate 621 having a plurality of V-shaped grooves 624. A longest one of the V-shaped grooves 614 spans from one corner of the substrate 611 to a diagonally opposite corner of the substrate 611. A longest one of the V-shaped grooves 624 spans from one corner of the substrate 621 to a diagonally opposite corner of the substrate 621. Further, the V-shaped grooves 614 of the first prism sheet 610 are oriented transversely relative to the V-shaped grooves 624 of the second prism sheet 620.

In each of the above-described embodiments, the angle within the range from 5° to 44.9° of each of the prism sheets can configured according to any particular application in order to improve and optimize the characteristics of brightness and view angle. Thus an associated device such as a backlight module employing the prism or prism module can provide good viewing performance.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A prism sheet, comprising:
a substrate comprising an incident surface and an emitting surface opposite to each other; and
a plurality of parallel V-shaped grooves provided at the emitting surface, wherein each of the V-shaped grooves maintains an angle relative to a main side of the substrate, and the angle is in the range from 5° to 44.9°.

2. The prism sheet as claimed in claim 1, wherein the angle is approximately 30°.

3. The prism sheet as claimed in claim 1, wherein the angle is approximately 5°.

4. The prism sheet as claimed in claim 1, wherein the angle is approximately 44.9°.

5. The prism sheet as claimed in claim 1, wherein the substrate is generally rectangular.

6. The prism sheet as claimed in claim 5, wherein a longest one of the V-shaped grooves spans from one corner of the substrate to a diagonally opposite corner of the substrate.

7. A prism sheet module, comprising:
a first prism sheet above a second prism sheet;
wherein at least one of the first and second prism sheets comprises a substrate, the substrate comprises an incident surface and an emitting surface opposite to each other, and a plurality of parallel V-shaped grooves provided at the emitting surface, each of V-shaped grooves maintains an angle relative to a main side of the substrate, and the angle is in the range from 5° to 44.9°.

8. The prism sheet module as claimed in claim 8, wherein the angle is approximately 30°.

9. The prism sheet module as claimed in claim 8, wherein the angle is approximately 5°.

10. The prism sheet module as claimed in claim 8, wherein the angle is approximately 44.9°.

11. The prism sheet module as claimed in claim 8, wherein the substrate is generally rectangular.

12. The prism sheet module as claimed in claim 11, wherein a longest one of the V-shaped grooves spans from one corner of the substrate to a diagonally opposite corner of the substrate.

13. The prism sheet module as claimed in claim 8, each of the first and second prism sheets comprises a substrate and a plurality of parallel V-shaped grooves, and in each of the first and second prism sheets, the V-shaped grooves maintain an angle relative to a main side of the substrate, and the angle is in the range from 5° to 44.9°.

14. The prism sheet module as claimed in claim 13, wherein the V-shaped grooves of the first prism sheet are oriented transversely relative to the V-shaped grooves of the second prism sheet.

15. The prism sheet module as claimed in claim 14, wherein in each of the first and second prism sheets, the angle is approximately 30°.

16. The prism sheet module as claimed in claim 14, wherein in each of the first and second prism sheets, the angle is approximately 5°.

17. The prism sheet module as claimed in claim 14, wherein in each of the first and second prism sheets, the angle is approximately 44.9°.

18. The prism sheet module as claimed in claim 14, wherein the substrate of each of the first and second prism sheets is generally rectangular, and wherein in each of the first and second prism sheets, a longest one of the V-shaped grooves spans from one corner of the substrate to a diagonally opposite corner of the substrate.

19. A prism sheet module for use with a liquid crystal display, comprising:
a first prism structure located above a second prism structure;
each of said first and second prism structures defining a plurality of parallel V-shaped grooves, wherein
the V-shaped grooves in the first prism structure extend along a first direction, and those in the second prism structure extend along a second direction not in a parallel or perpendicular manner with regard to the first direction.

20. The prism sheet module as claimed in claim 19, wherein the first prism structure and said second prism structure are of a rectangular form while said first and second directions are not either parallel or perpendicular to either longitudinal side or transverse side of said rectangular form.
